(19) United States
(12) Patent Application Publication
(10) Pub. No.: US 2008/0236226 A1
(43) Pub. Date: Oct. 2, 2008

(54) Cylinder Tumbler Lock Mechanism

(76) Inventor: Barrie Samuel Harper, Wolver-hampton (GB)

Correspondence Address: NOTARO AND MICHALOS, 100 DUTCH HILL ROAD, SUITE 110, ORANGEBURG, NY, 10962-2100, US

(21) Appl. No.: 12/064,280

(22) PCT Filed: Aug. 23, 2006
(86) PCT No.: PCT/GB2006/003153

§ 371 Date: Feb. 20, 2008

(30) Foreign Application Priority Data
Aug. 26, 2005 (GB) 0517568.2

(51) Int. Cl. E05B 25/00

(52) U.S. Cl. 70/491

(57) ABSTRACT

A cylinder tumbler lock mechanism comprises a plug having a row of slots formed therein, each slot containing a tumbler. The tumbler includes a formation for engagement with a side of a key. The tumbler is slidably mounted in the slot and movable in a first direction from: (i) a locking position in which one end of the tumbler projects out of an open end of the slot, into (ii) a decoding position in which further movement of the tumbler in the first direction is blocked. For at least two tumblers that differ from one another, the height of the formation, when in the decoding position, is substantially identical. Thus, the lock is made considerably more difficult to decode.

The present invention relates to a cylinder tumbler lock mechanism. The invention is particularly, but not exclusively concerned with disc tumbler lock mechanisms for use in vehicles.

There is always a desire to make locks more secure. There are known cylinder tumbler locks mechanisms that are difficult to de-code.

WO 2004/085772 A1 discloses a cylinder tumbler lock mechanism comprising a plug rotatably mounted in a housing, the plug including a row of slots formed therein, each slot extending in a direction transverse to the length of the row and containing a tumbler with a first side extension for supporting a spring and having an opening there through for allowing insertion of a key into the plug, the tumbler including a formation on a side edge of the opening for engagement with a side of a key inserted through the opening, and the tumbler being slidably mounted in the slot and movable against a force of a spring in a first direction from a locking position, in which one end of the tumbler projects out of an open end of the slot, into a decoding position, in which further movement of the tumbler in the first direction is blocked by an abutment of a second side extension against a plug, wherein for at least two tumblers that differ from one another, the height of the parts of the formations which the key engages during use, are substantially identical when said two tumblers are in the decoding position.

The above described arrangement makes the lock mechanism considerably more difficult to decode. In particular, differently shaped tumblers will be difficult to identify, as the formation on the different tumblers will be at the same height when the different tumblers are lifted to their furthest extent.

A disadvantage of this construction is that for the blocking of the movement of the tumbler an additional second side extension on the tumbler and an additional cut-out or a groove in the plug is necessary.

It is an object of the invention to simplify the production technology of such a cylinder tumbler locks mechanisms.

According to the invention the movement of the tumbler in the first direction is blocked by an abutment of the extension against the plug. In such an embodiment no additional cut-out or a groove in the plug is necessary to be made.

Preferably the extension abuts on a protrusion in a cavity next to slot.

The tumbler may comprise two extensions for supporting a spring (the lock mechanism not necessarily, however, including a spring located between both extensions and the plug). Movement of the tumbler in the first direction may be blocked by abutment of both the extensions against the plug.

It will be understood that reference to “height” should be interpreted as the height, in the direction of movement of the tumbler, relative to an appropriate datum in the lock mechanism, for example the longitudinal axis of the plug. In use, the lock may have any appropriate orientation suitable to its particular application, and the height is not necessarily in a vertical dimension.

Various embodiments of the invention will now be described, by way of example only, with reference to the accompanying schematic drawings of which:

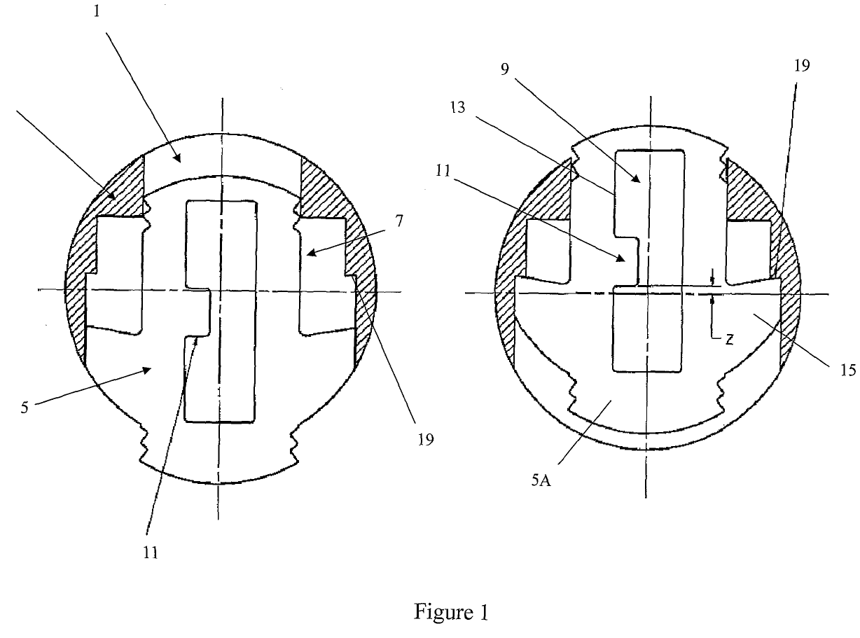

FIG. 1 shows a number 1 tumbler in the locking position and the decoding position;

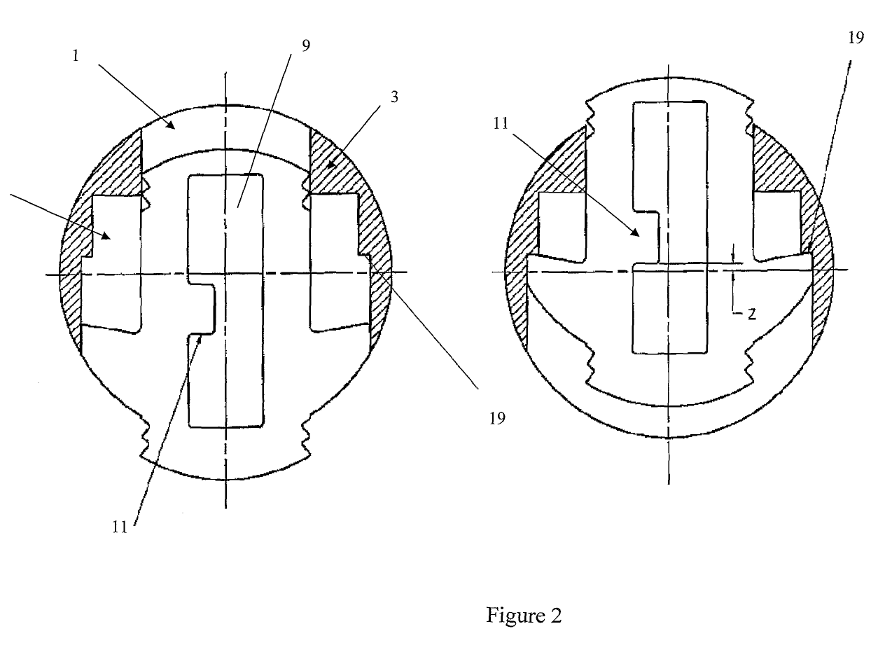

FIG. 2 shows a number 2 tumbler in the locking position and the decoding position;

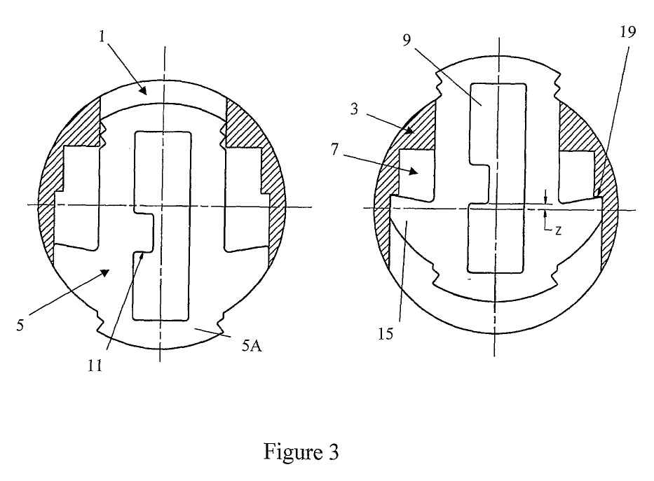

FIG. 3 shows a number 3 tumbler in the locking position and the decoding position;

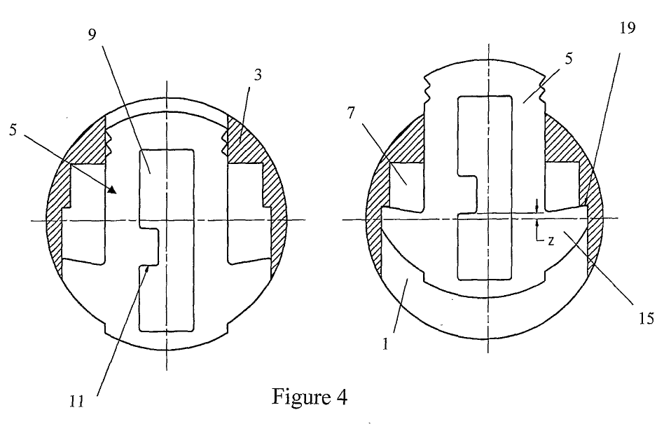

FIG. 4 shows a number 4 tumbler in the locking position and the decoding position.

A cylinder tumbler lock mechanism comprises a number of slots arranged in a row along the length of a plug. FIGS. 1 to 4 show a sectional view through the face of four different slots in the plug.

Each slot 1 extends in a direction transverse to the length of the plug 3 and contains a tumbler 5. The main body of each slot 1 is of rectangular cross-section. On either side of each slot 1 there is further defined a cavity 7 which is open to the lower surface of the plug 3 but closed to the upper surface.

Each tumbler 5 comprises an opening 9, for allowing insertion of a key into the plug 1, a formation 11 on a side edge 13 of the opening 9, and an extension 15. The tumblers 5 in FIGS. 1 to 4 differ in geometry from one another. The skilled man will understand that a particular geometry of a tumbler is associated with a particular number. The tumblers shown in FIGS. 1 to 4 are referred to herein as tumbler numbers 1 to 4 respectively.

Each tumbler 5 is dimensioned such that it may be slidably mounted in a slot 1 and such that the extension 15 fits into the cavity 7. Accordingly, the thickness of the tumblers (not shown) is much less than their height and width.

Referring to FIGS. 1 to 4, each tumbler 5 is slidably mounted in the slot 1. The left-hand drawing in each Figure shows the tumbler in a locking position in which one end 5A of the tumbler 5 projects through the bottom of the slot 1. One end of a compression spring (not shown) bears against the plug 1 in one of the cavities 7, whilst the other end of the spring 17 bears against the extension 15 on the tumbler 5. The tumbler 5 is thereby resiliently biased in a downward direction into the locking position.

In the locking position rotational movement of the plug 3 about its longitudinal axis is prevented by the ends 5A of the tumblers 5 abutting the housing (not shown) upon rotation of the plug 1. All the tumblers 5 are movable from the locking position into a decoding position (shown in the right-hand drawings of the Figures). It will be understood that the tumblers are also moveable between the locking position and an unlocking position (not shown).

In the decoding position, the extension 15 of the tumbler 5 abuts a protrusion 19 on the inner surface of the plug 3. The lock is arranged such that for each of the four tumblers shown (which differ from one another in geometry) the height of the lower surface of the formation 11, when the tumblers are in the decoding position, is identical. The height shown in FIGS. 1 to 4 is indicated by dimension Z and is measured relative to the longitudinal axis of the plug in the direction of movement of the tumbler.

Such an arrangement makes it particularly difficult to decode the lock. When each tumbler 5 is lifted until movement is blocked, the location of the formation 11 is the same. Therefore, the particular number of each tumbler is difficult to deduce, making it difficult to deduce a suitable cut to a key for use in the lock.

Whilst the present invention has been described and illustrated with reference to a particular embodiment, it will be appreciated by those of ordinary skill in the art that the invention lends itself to many different variations not specifically illustrated herein. For that reason, reference should be made to the claims for determining the true scope of the present invention. By way of example, two variations to the above-described embodiments will now be described.

Firstly, all the tumblers in the cylinder tumbler lock mechanism need not differ from one another; for example, two tumblers might be identical to one another. Secondly, the movement of the tumblers in the decoding position may be blocked by a different feature, for example an appropriately dimensioned part of the housing.

1. A cylinder tumbler lock mechanism comprising a plug (3) rotatably mounted in a housing, the plug (3) including a row of slots (1) formed therein, each slot (1) extending in a direction transverse to the length of the row and containing a tumbler (5) with a side extension (15) for supporting a spring and having an opening (9) therethrough for allowing insertion of a key into the plug (3), the tumbler (5) including a formation (11) on a side edge (13) of the opening (9) for engagement with a side of a key inserted through the opening (9), and the tumbler (5) being slidably mounted in the slot (1) and movable against a force of a spring in a first direction from a locking position in which one end of the tumbler (5) projects out of an open end of the slot (1), into a decoding position in which further movement of the tumbler (5) in the first direction is blocked, wherein the height (Z) of parts of the formations (11), on which the key acts, for at least two tumblers (5) that differ from one another are substantially identical when said two tumblers (5) are in the decoding position, wherein the movement of the tumbler (5) in the first direction is blocked by abutment of the side extension (15) against the plug (3).

2. A cylinder tumbler lock mechanism according to claim 1, wherein the side extension (15) abuts on a protrusion (19) in a cavity (7) next to slot (1).

3-7. (canceled)
